(19) United States
(12) Patent Application Publication
(10) Pub. No.: US 2017/0290307 A1
(43) Pub. Date: Oct. 12, 2017

(54) Actuated Aquarium Decoration System

(71) Applicant: Jeffrey David Boschert, Pleasant Hill, CA (US)

(72) Inventor: Jeffrey David Boschert, Pleasant Hill, CA (US)

(21) Appl. No.: 15/094,258

(22) Filed: Apr. 8, 2016

(51) Int. Cl. A01K 63/00; A01K 63/04; A01K 63/06

(52) U.S. Cl. CPC A01K 63/006; A01K 63/06; A01K 63/042

(57) ABSTRACT

An actuated aquarium decoration system is placed within an aquarium in order to provide an aesthetic appeal to onlookers of the aquarium. The actuated aquarium decoration system includes an aquarium decoration, an actuation mechanism, and a control system. The aquarium decoration is an object placed into the aquarium to provides a theme or habitat within the aquarium. The actuation mechanism engages an accenting feature of the aquarium decoration in order to provide motion or character to the aquarium decoration. The control system the duration, intensity, and frequency of the accenting feature through managing the output of the actuation mechanism.

### FIELD OF THE INVENTION

The present invention relates generally to aquarium decorations. More specifically, the present invention relates to aquarium decorations with actuated accenting features to provide aquarium decorations with more aesthetic appeal.

### BACKGROUND OF THE INVENTION

Aquariums are often used for decorative purposes in homes, offices, and other places of business to display fish or other aquatic life. Decorations are placed within aquariums in order to provide an additional aesthetic appeal to the aquarium as well as a habitat for aquatic life within the aquarium. Some decorations implement an air pump to accentuate the decoration placed in the aquarium; however, the air flow provided to the decoration is typically a constant flow of air. The flow of air is used to simulate breathing for a diver or other sea-creatures by creating bubbles from the decoration. As the flow of air is usually constant, the breathing tends to be observed as unrealistic.

The present invention seeks to provide additional methods of actuating decorations in order to provide additional functionalities and aesthetic capabilities over previously implemented aquarium decorations. The present invention implements an actuation mechanism to display or move an accenting feature of the decoration. The actuating mechanism is set on a control system to time the actuation of the accenting feature, such that the accenting feature has a more natural feel of the decoration.

### BRIEF DESCRIPTION OF THE DRAWINGS

FIG. 1 is a perspective view for an embodiment of the present invention, wherein the aquarium decoration is a submarine.

FIG. 2 is a schematic view of the present invention, wherein the actuation mechanism is a hydraulic pump positioned within the aquarium and the accenting feature includes a rotatable ornament.

FIG. 3 is a schematic view of the present invention, wherein the actuation mechanism is an air pump and the accenting feature includes a rotatable ornament.

FIG. 4 is a schematic view of the present invention, wherein the actuation mechanism is an air pump and the accenting feature includes an air pipe.

FIG. 5 is a schematic view of the present invention, wherein the actuation mechanism is a reciprocating actuation mechanism and the accenting feature includes a reciprocating ornament.

FIG. 6 is a schematic view of the present invention, wherein the actuation mechanism includes a cam shaft and the accenting feature includes a plurality of cam-actuatable ornaments.

FIG. 7 is a schematic view of the present invention, wherein the actuation mechanism includes a flexible drive shaft and the accenting feature includes a rotatable ornament.

FIG. 8 is a schematic view of the present invention, wherein the actuation mechanism includes a motor and the accenting feature includes an includes a rotatable ornament which are coupled together through a first magnetic base and a second magnetic base.

FIG. 9 is a schematic view of the present invention, wherein the actuation mechanism includes a light source and the accenting feature includes a light emitting terminal.

FIG. 10 is a schematic view of the present invention, wherein the actuation mechanism includes a motor, a spool and a tether and the accenting feature is a linear-translating ornament.

### DETAIL DESCRIPTIONS OF THE INVENTION

All illustrations of the drawings are for the purpose of describing selected versions of the present invention and are not intended to limit the scope of the present invention.

The present invention is an actuated aquarium decoration system which provides additional functionalities for aquarium decorations over previous animated decorations. Previous animated decorations required a constant air flow to provide a constant flow of bubbles or buoyancy to a decoration. The present invention seeks to improve upon such previous animated decorations by providing a system which allows for features of an aquarium decoration to be manipulated in order to display a more realistic animated decoration.

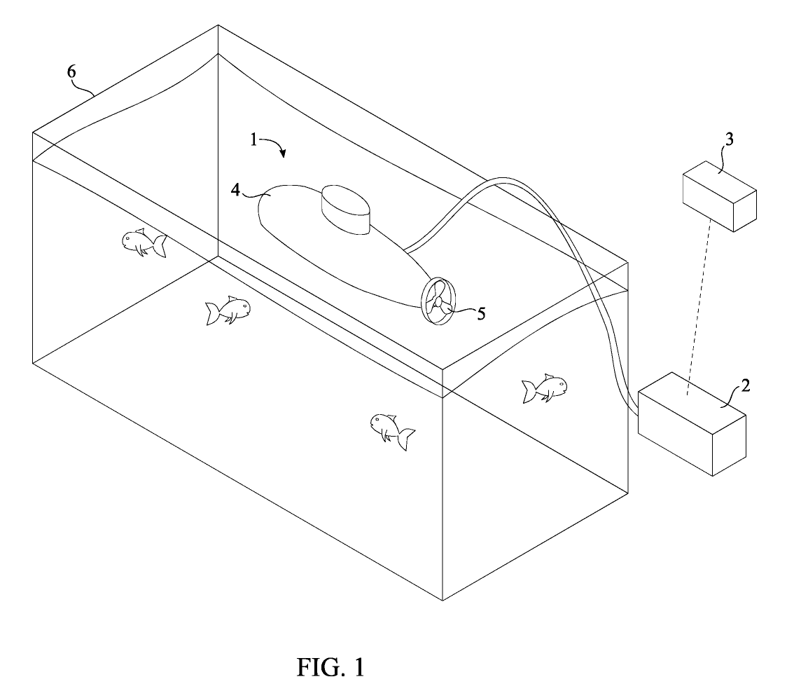

In accordance to FIG. 1, the present invention comprises an aquarium decoration 1, an actuation mechanism 2, and a control system 3. The aquarium decoration 1 is an aesthetic ornament which is placed inside an aquarium 6. In accordance to the preferred embodiment of the present invention, the present invention comprises an aquarium 6. The aquarium 6 is a transparent container which holds a volume of water and supports a habitat for fresh and salt-water fish, anemones, and other aquatic life. The aquarium decoration 1 is positioned within the aquarium 6 in order to display the aesthetics of the aquarium decoration 1 as well as providing a habitat for aquatic life. The aquarium decoration 1 may include, but is not limited to, sunken ships, divers, sea-creatures, coral formations, treasure chests, or other similar aquarium decorations.

The aquarium decoration 1 comprises a decoration body 4 and an accenting feature 5. The decoration body 4 is the structural base of the aquarium decoration 1 that supports the accenting feature 5. The decoration body 4 may include, but is not limited to: hulls, decks, or masts of a ship; bodies of divers or other sea-creatures; coral structures; treasure chest bases; or similar fixed portions of the aquarium decoration 1. The accenting feature 5 is an aesthetic feature that is used to animate the aquarium decoration 1 which brings a sense of realism to the aquarium decoration 1. The accenting feature 5 is integrated into the decoration body 4, such that the accenting feature 5 may be displayed to users viewing the aquarium decoration 1 within an aquarium 6. The accenting feature 5 may include, but is not limited to: propellers, flags, or room lights of a ship; appendages of divers or sea-creatures; sea-creatures within coral structures or ship wreckage; treasure chest lids; clam, oyster, or scallop shells; or similar features of aquarium decoration 1 which can be manipulated for aesthetic appeal.

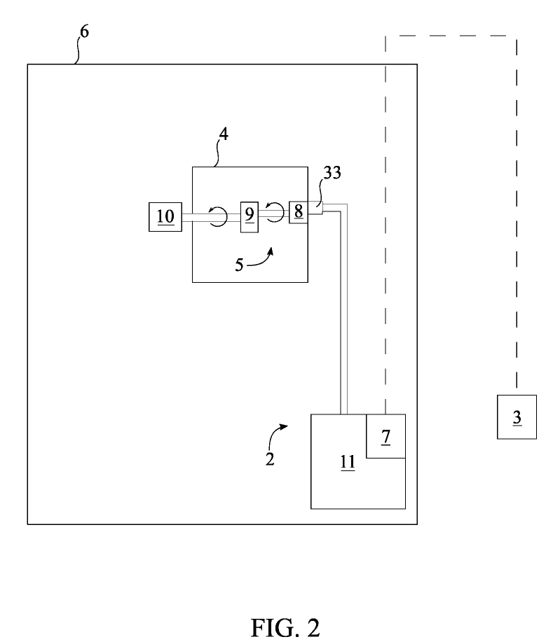

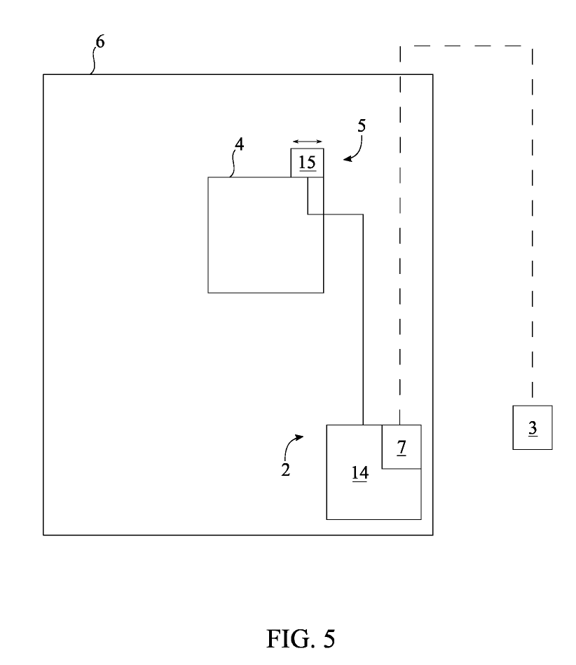

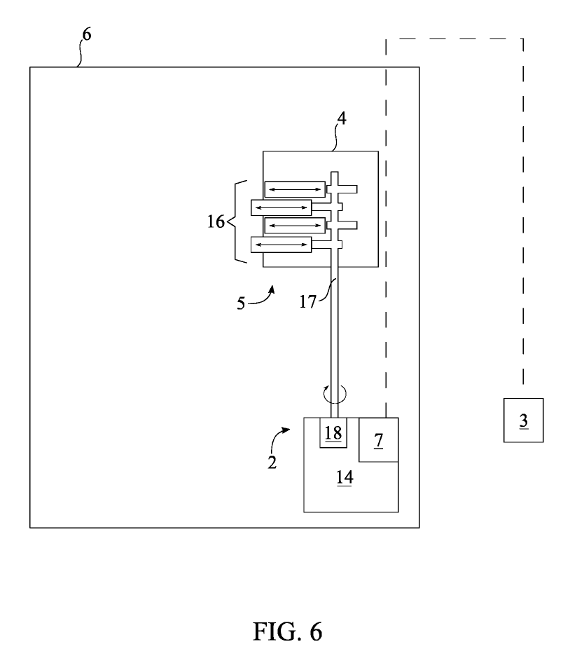

The actuation mechanism 2 manipulates the accenting feature 5 to exemplify the aesthetic feature which the aquarium decoration 1 portrays. The actuation mechanism 2 is operatively coupled to the accenting feature 5, wherein the actuation mechanism 2 is used to activate the accenting feature 5, move appendages, rotate propellers, open and close lids, etc. In some embodiments of the present invention, the actuation mechanism 2 is positioned external to the aquarium 6 in order to prevent short circuiting an external electrical circuit to which the actuation mechanism 2 is electrically coupled. In some embodiments of the present invention, the actuation mechanism 2 is positioned within the aquarium 6. In order to accomplish this, the actuation mechanism 2 comprises a waterproof housing 7, as shown in FIG. 2, FIG. 5 and FIG. 6. The waterproof housing 7 protects the electrical components and connections of the actuation mechanism 2. The control system 3 is communicatively and sealably coupled to the actuation mechanism 2 such that control signals from the control system 3 may be communicated to the actuation mechanism 2 to manipulate the accenting feature 5.

The control system 3 is a controller which manipulates the output of the actuation mechanism 2 and, subsequently, the manipulation of the accenting feature 5. The control system 3 controls functionalities such as the intensity, duration, or interval frequency of the manipulation of the accenting feature 5.

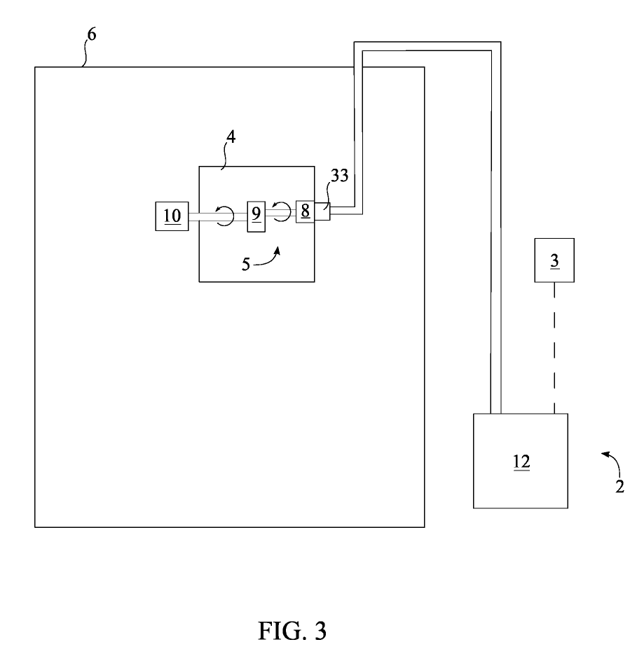

In some embodiments of the present invention, the accenting feature 5 comprises a bladed wheel 8, a gearset 9 and a rotatable ornament 10, as detailed in FIG. 2 and FIG. 3. The bladed wheel 8 is a wheel with blades perpendicular to the wheel such that pressure on a broad side of the blades creates a moment about the center of the wheel. The bladed wheel 8 is rotatably connected to the decoration body 4. The gearset 9 transfers the rotational motion from the bladed wheel 8 to the rotatable ornament 10. The rotatable ornament 10 is any rotatable aesthetic fixture of the aquarium decoration 1 which includes, but is not limited to, propellers and light house lights. The rotatable ornament 10 is rotatably connected to the decoration body 4 such that the feature is able to rotate in order to animate the aquarium decoration 1. The bladed wheel 8 is torsionally coupled to the rotatable ornament 10 through the gearset 9. In some embodiments of the present invention, the actuation mechanism 2 comprises a hydraulic pump 11, in accordance to FIG. 2. The hydraulic pump 11 creates a pressure difference to force water through the hydraulic pump 11. An outlet 33 of the hydraulic pump 11 is oriented towards the bladed wheel 8 such that the force of the water rotates the bladed wheel 8 and subsequently the rotatable ornament 10. In some other embodiments of the present invention, the actuation mechanism 2 comprises an air pump 12, in accordance to FIG. 3. The air pump 12 increases air pressure in order to create a flow of air. An outlet 33 of the air pump 12 is oriented towards the bladed wheel 8 such that the force of the air flowing from the air pump 12 rotates the bladed wheel 8 and subsequently actuating the rotatable ornament 10.

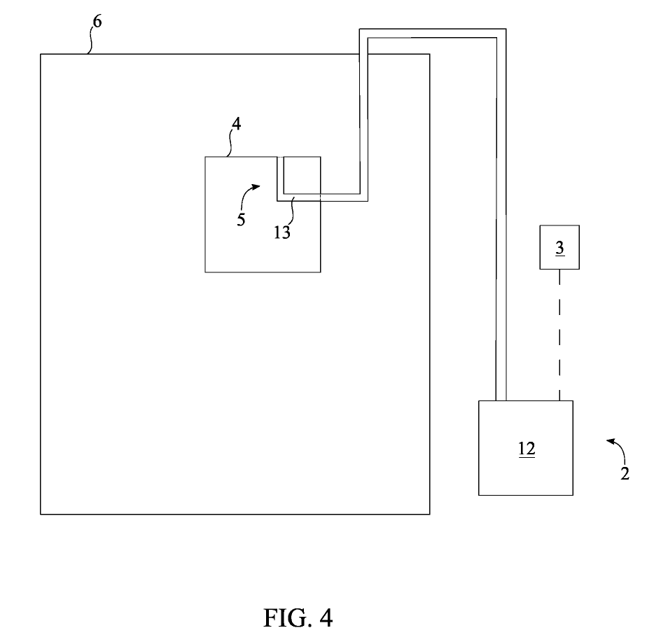

In another embodiment of the present invention, the actuation mechanism 2 comprises an air pump 12 and the accenting feature 5 comprises an air pipe 13, as shown in FIG. 4. The air pump 12 is in fluid communication with the air pipe 13. The air pipe 13 traverses through the decoration body 4. This embodiment allows for the aquarium decoration 1 to exhibit such behaviors as breathing or passing gas as air flows through the aquarium decoration 1, wherein the aquarium decoration is a diver. The control system 3 manages how frequency of the air flow to exhibit realistic breathing or flatulence.

In accordance to FIG. 5 and another embodiment of the present invention, the actuation mechanism 2 comprises a reciprocating actuation mechanism 14 in order to facilitate a back and forth motion to the accenting feature 5. The accenting feature 5 comprises a reciprocating ornament 15 which includes, but is not limited to, waving arms, waving tentacles, sea-creatures emerging and receding into terrain, filter-feeding action of barnacles, etc. The reciprocating actuation mechanism 14 is mechanically tethered to the reciprocating ornament 15, such that the motion of the reciprocating actuation mechanism 14 translates to the reciprocating ornament 15. The control system 3 manages the velocity and frequency of the reciprocating motion of the reciprocating ornament 15.

In still another embodiment of the present invention, the actuation mechanism 2 comprises a rotating actuation mechanism 14. The rotating actuation mechanism 14 comprises a camshaft 17 and a motor 18, in accordance to FIG. 6. The motor 18 drives the rotation of the camshaft 17 while the camshaft 17 facilitates the motion of the accenting feature 5. A driveshaft of the motor 18 is torsionally connected to the camshaft 17 in order to rotate the camshaft 17 and subsequently the accenting feature 5. The accenting feature 5 comprises a plurality of cam-actuatable ornaments 16. An example of the plurality of cam-actuatable ornaments 16 is a plurality sea-creatures which emerges or recedes into terrain in a predetermined sequence. The plurality of cam-actuatable ornaments 16 is bistably mounted into the decoration body 4. Each of the plurality of cam-actuatable ornaments 16 is engaged by a corresponding cam from the camshaft 17 such that each of the plurality of cam-actuatable ornaments 16 extends or recedes as the motor 18 rotates the camshaft 17.

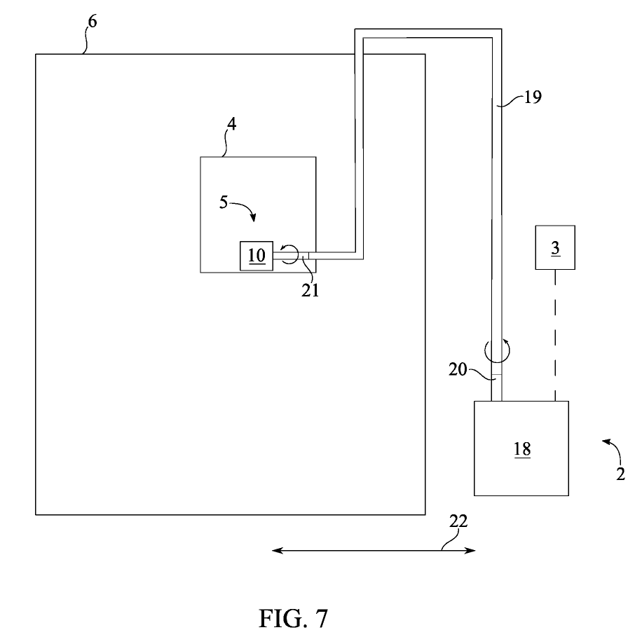

In another embodiment of the present invention where the accenting feature 5 comprises a rotatable ornament 10, the actuation mechanism 2 comprises a motor 18 and a flexible driveshaft 19, as detailed in FIG. 7. The rotatable ornament 10 is rotatable connected to the decoration body 4. An input 20 of the flexible driveshaft 19 is torsionally connected to the motor 18 and an output 21 of the flexible driveshaft 19 is connected to the rotatable ornament 10. The input 20 of the flexible driveshaft 19 and the output 21 of the flexible driveshaft 19 are offset from each other by an aesthetically pleasing distance such as to move the motor 18 out of visual sight from onlookers of the aquarium decoration 1. The incorporation of a flexible driveshaft 19 allows the decoration body 4 to be moved while still being connected to the motor 18 in order to facilitate motion of the accenting feature 5. The flexibility of the flexible drive shaft 19 also allows for the flexible drive shaft 19 to be positioned over a wall of the aquarium 6, such that the actuation mechanism 2 is positioned outside of the aquarium 6 and the aquarium decoration 1 is positioned within the aquarium 6. This prevents electrical components from being submerged while allowing the rotational motion form the motor 18 to be transferred to the accenting feature 5.

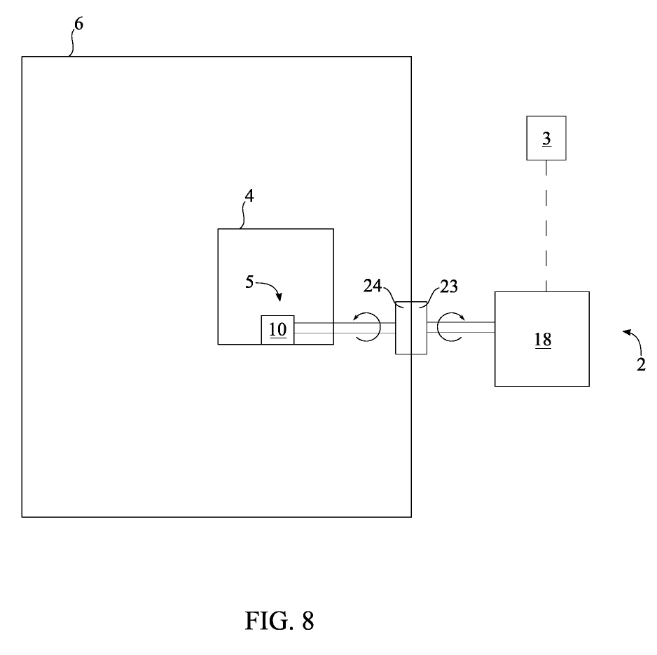

In still another embodiment of the present invention where the accenting feature 5 comprises a rotatable ornament 10, the actuation mechanism 2 comprises a motor 18, a first magnet base 23, and a second magnet base 24, in accordance to FIG. 8. The rotatable ornament 10 is rotatably connected to the decoration body 4. The first magnet base 23 is torsionally connected to the motor 18. The second magnet base 24 is torsionally connected to the rotatable ornament 10. The first magnet base 23 and the second magnet base 24 are magnetically and torsionally coupled to each other in order to transfer the torque of the motor 18 to the rotatable ornament 10. This configuration also allows for the transfer of the torque through a wall of the aquarium 6, wherein the first magnet base 23 is opposite to the second magnet base 24 about the wall of the aquarium 6.

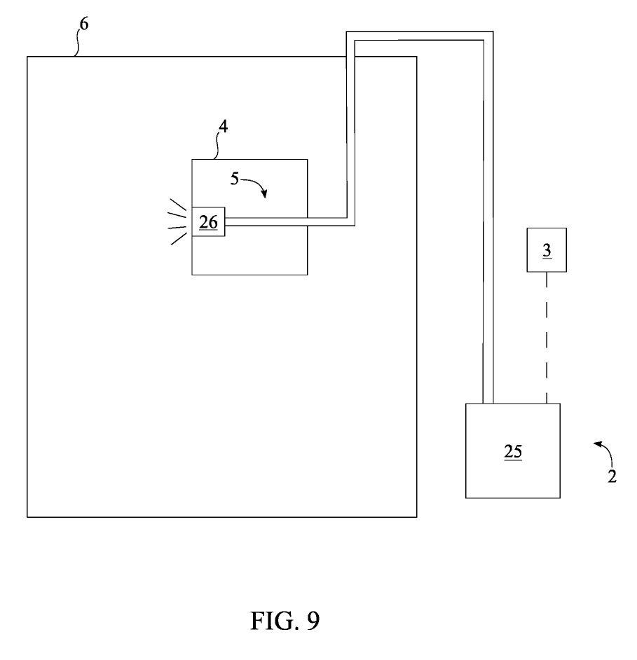

In yet another embodiment of the present invention, the actuation mechanism 2 comprises a light source 25 and the accenting feature 5 comprises a light emitting terminal 26, as detailed in FIG. 9. The light emitting terminal 26 is integrated into the decoration body 4, where the light emitting terminal 26 includes, but is not limited to, eyes, windows, beacons of lighthouses, or similar features. The light source 25 is in optical communication with the light emitting terminal 26. The light source 25 is preferred to be in optical communication with the light emitting terminal 26 through a fiber optic cable in order to prevent an electrical current flow from traversing into a volume of water. As fiber optic cables translate light as a focused beam, the light emitting terminal 26 disperses the light emission in a manner which is visible and aesthetically pleasing to onlookers of the aquarium decoration 1.

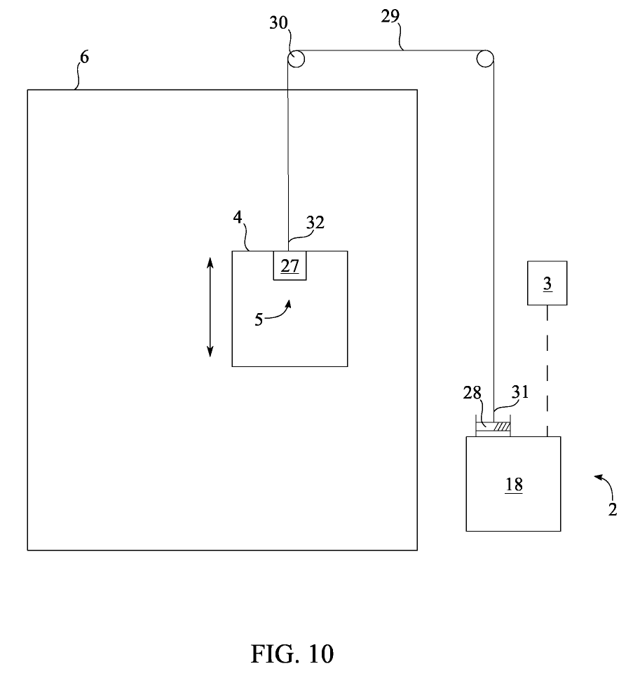

In yet another embodiment of the present invention shown in FIG. 10, the accenting feature 5 comprises a linear-translating ornament 27 which is able to be raised or lowered, such as a diver, sea creatures, or other features which can vary in the depth of an aquarium 6. The actuation mechanism 2 comprises a motor 18, a spool 28, a tether 29, and a pulley 30. The spool 28 is torsionally mounted to the motor 18 such that the spool 28 rotates as the motor 18 is powered. A first end 31 of the tether 29 is adjacently connected to the spool 28 such that the tether 29 is able coil about the spool 28 as the spool 28 rotates. A second end 32 of the tether 29 is adjacently connected to the linear-translating ornament 27. The tether 29 is slidably and tensionably engaged about the pulley 30. The pulley 30 is positioned between the first end 31 and the second end 32. As the tether 29 coils about the spool 28, the linear-translating ornament 27 is manipulated towards the pulley 30. The motor 18 is preferred to be a reversible motor 18 such that the tether 29 is able to be coiled and uncoiled about the spool 28 automatically through manipulation from the control system 3. By coiling and uncoiling the tether, the linear-translating ornament 27, such as a diver or jellyfish, simulates movement for the aquarium decoration 1, according to the aesthetic of the aquarium decoration 1.

Although the invention has been explained in relation to its preferred embodiment, it is to be understood that many other possible modifications and variations can be made without departing from the spirit and scope of the invention as hereinafter claimed.

What is claimed is:

1. An actuated aquarium decoration system comprises:
an aquarium decoration;
an actuation mechanism;
a control system;
the aquarium decoration comprises a decoration body and an accenting feature;
the accenting feature being integrated into the decoration body;
the actuation mechanism being operatively coupled to the accenting feature, wherein the actuation mechanism is used to activate the accenting feature; and
the control system being communicably coupled to the actuation mechanism.

2. The actuated aquarium decoration system, as claimed in claim 1, comprises:
an aquarium; and
the aquarium decoration being positioned within the aquarium.

3. The actuated aquarium decoration system, as claimed in claim 2, comprises:
the actuation mechanism being positioned external to the aquarium.

4. The actuated aquarium decoration system, as claimed in claim 2, comprises:
the actuation mechanism comprises a waterproof housing;
the control system being communicatively and sealably coupled to the actuation mechanism though the waterproof housing; and
the actuation mechanism being positioned within the aquarium.

5. The actuated aquarium decoration system, as claimed in claim 1, comprises:
the accenting feature comprises a bladed wheel, a gearset, and a rotatable ornament;
the bladed wheel being rotatably connected to the decoration body;
the rotatable ornament being rotatably connected onto the decoration body; and
the bladed wheel being torsionally coupled to the rotatable ornament through the gearset.

6. The actuated aquarium decoration system, as claimed in claim 5, comprises:
the actuation mechanism comprises a hydraulic pump; and
an outlet of the hydraulic pump being oriented towards bladed wheel.

7. The actuated aquarium decoration system, as claimed in claim 5, comprises:
the actuation mechanism comprises an air pump; and
an outlet of the air pump being oriented towards the bladed wheel.

8. The actuated aquarium decoration system, as claimed in claim 1, comprises:
the actuation mechanism comprises an air pump;
the accenting feature comprises an air pipe;
the air pump being in fluid communication with the air pipe; and
the air pipe traversing through the decoration body.

9. The actuated aquarium decoration system, as claimed in claim 1, comprises:
the actuation mechanism comprises a reciprocating actuation mechanism;
the accenting feature comprises a reciprocating ornament; and
the reciprocating actuation mechanism being mechanically tethered to the reciprocating ornament.

10. The actuated aquarium decoration system, as claimed in claim 1, comprises:
the actuation mechanism comprises a rotating actuation mechanism;
the accenting feature comprises a plurality of cam-actuatable ornaments;
the rotating actuation mechanism comprises a camshaft and a motor;
a driveshaft of the motor being torsionally connected to the camshaft;
the plurality of cam-actuatable ornaments being bistably mounted into the decoration body; and
each of the plurality of cam-actuatable ornaments being engaged by a corresponding cam from the camshaft.

11. The actuated aquarium decoration system, as claimed in claim 1, comprises:
the accenting feature comprises a rotatable ornament;
the actuation mechanism comprises a motor and a flexible driveshaft;
the rotatable ornament being rotatably connected onto the decoration body;
an input of the flexible driveshaft being torsionally connected to the motor;
an output of the flexible driveshaft being torsionally connected to the rotatable ornament; and
the input of the flexible driveshaft and the output of the flexible driveshaft being offset from each other by an aesthetically-pleasing distance.

12. The actuated aquarium decoration system, as claimed in claim 1, comprises:
the accenting feature comprises a rotatable ornament;
the actuation mechanism comprises a motor, a first magnet base, and a second magnet;
the rotatable ornament being rotatably connected onto the decoration body;
the first magnetic base being torsionally connected to the motor;
the second magnetic base being torsionally connected to the rotatable ornament; and
the first magnetic base and the second magnetic base being magnetically and torsionally coupled to each other.

13. The actuated aquarium decoration system, as claimed in claim 1, comprises:
the actuating mechanism comprises a light source;
the accenting feature comprises a light emitting terminal;
the light emitting terminal being integrated into the decoration body; and
the light source being in optical communication with the light emitting terminal.

14. The actuated aquarium decoration system, as claimed in claim 1, comprises:
the accenting feature comprises a linear-translating ornament;
the actuation mechanism comprises a motor, a spool, a tether, and a pulley;
the spool being torsionally mounted to the motor;
a first end of the tether being adjacently connected to the spool;
a second end of the tether being adjacently connected to the linear-translating ornament;
the tether being slidably and tensionably engaged about the pulley; and
the pulley being positioned between the first end and the second end.

15. The actuated aquarium decoration system, as claimed in claim 14, wherein the motor is a reversible motor.
